(19) United States
(12) Patent Application Publication
(10) Pub. No.: US 2012/0219845 A1
(43) Pub. Date: Aug. 30, 2012

(54) SECONDARY BATTERY

(75) Inventor: Daisuke Chiba, Tokyo (JP)

(73) Assignee: MITSUBISHI HEAVY INDUSTRIES, LTD., Tokyo (JP)

(21) Appl. No.: 13/405,655

(22) Filed: Feb. 27, 2012

(30) Foreign Application Priority Data
Feb. 28, 2011 (JP) 2011-042333

(51) Int. Cl. H01M 2/02; H01M 10/02; H01M 2/30

(52) U.S. Cl. 429/153

(57) ABSTRACT

In a battery case main body of the lithium secondary battery, many positive electrode plates and negative electrode plates are stacked. Furthermore, these many positive electrode plates and negative electrode plates are bundled for each predetermined number of plates. In each bundle, the positive electrode plates are bonded to one strap-shaped current collector lead 22A and the negative electrode plates are bonded to one strap-shaped current corrector lead 22B. These current collector leads 22A and 22B are connected to a positive electrode terminal and a negative electrode terminal, respectively. Then, according to a length L of the current corrector leads 22A and 22B for each bundle, a width W of the current corrector leads 22A and 22B is varied, thereby making current collector resistances of the stacked bodies uniform.

### BACKGROUND OF THE INVENTION

1. Field of the Invention

The present invention relates to a secondary battery such as a lithium secondary battery.

2. Description of the Related Art

In recent years, as power supplies for various electronics, rechargeable and dischargeable secondary batteries are often used. In particular, because the lithium secondary batteries can be small in size, their capacity can be large, and their output can be high power, these lithium secondary batteries have attracted attention as power supplies for electric vehicles.

In the lithium secondary battery, positive electrode plates and negative electrode plates are alternately stacked and stored in a battery case. And a positive electrode and a negative electrode are provided to the battery case. One end of each of the positive electrode and the negative electrode is at the inside of the battery case and the other end of each of the positive electrode and the negative electrode is at the outside of the battery case. The electrode plates are bundled for each predetermined number of plates. Then, each of strap-shaped current collector leads is connected to the corresponding bundle, and these strap-shaped current collector leads are connected to the positive electrode or the negative electrode (for example, refer to Japanese Patent Laid-Open No. 2005-5215).

### SUMMARY OF THE INVENTION

Here, in the battery case, the bundles of the electrode plates (i.e., each of the bundles is hereinafter referred to as a “stacked body”) are stored. Depending on the distance to the electrode terminal, the length of the current collector lead from each stacked body to the electrode terminal is varied. Thus, electrical resistances of the current collector leads (i.e., current collector resistances) are varied.

When a certain current is taken out from a lithium secondary battery, the current is taken out much from the stacked body connected to the shortest current corrector lead, because electrical resistance of the stacked body is low. As a result, the stacked body deteriorates faster than the other stacked bodies. Therefore, the life of the lithium secondary battery might be short.

The present invention was accomplished based on such a technical problem, and has an object of providing a secondary battery capable of suppressing unevenness in deterioration among the stacked bodies and enhancing the life of the secondary battery.

The secondary battery according to the present invention includes: stacked bodies, each formed by alternately stacking positive electrode plates and negative electrode plates, in a battery case; a positive electrode terminal and a negative electrode terminal for communicating the inside of the battery case with the outside of the battery case; and strap-shaped current collector leads, each for electrically connecting the corresponding electrode plate and the corresponding electrode terminal, in each polarity, wherein at least either widths or thicknesses of the current collector leads are varied according to the length of the corresponding current collector lead connected to the corresponding stacked body among the stacked bodies.

According to the configuration described above, the electric resistances can be the same among the stacked bodies, although the current collector leads may have length different from each other.

Here, specifically, among the stacked bodies, at least either the widths or the thicknesses of the current collector leads are varied, in order that current collector resistance values of the stacked bodies are substantially the same.

Or the secondary battery according to the present invention includes: stacked bodies, each formed by alternately stacking positive electrode plates and negative electrode plates, in a battery case; a positive electrode terminal and a negative electrode terminal for communicating the inside of the battery case with the outside of the battery case; and strap-shaped current collector leads, each for electrically connecting the corresponding electrode plate and the corresponding electrode terminal, in each polarity, wherein the electrode plate and the corresponding current collector lead are electrically connected by connecting a tub formed in the electrode plate and one end of the corresponding current collector lead, and its bonded area is designed in order that current corrector resistance values of the stacked bodies are substantially the same with considering lengths, widths, and thicknesses of the current collector leads connected to the stacked bodies.

According to the present invention, according to the length of the current collector lead, at least either one of the width and the thickness of the current collector lead is different from the other current collector leads. Therefore, among the stacked bodies, the electrical resistances can be the same, although the lengths of the current collector leads might be different. Thus, because the current collector resistances among the stacked bodies can be the same, currents can be prevented from being taken out much from a specific stacked body. Therefore, deteriorations of the stacked bodies can be similar. As a result, the life of the secondary battery can be enhanced.

### BRIEF DESCRIPTION OF THE DRAWINGS

FIG. 1 is a perspective view of an outer view of a lithium secondary battery in an embodiment;

FIG. 2 is a perspective sectional view of a schematic structure of the lithium secondary battery;

FIG. 3 is a perspective view of a relation between positive electrode plates and negative electrode plates alternately stacked and current collector leads;

FIG. 4 is a view of a state in which a lid is mounted on a battery case main body;

FIG. 5 is a view of a state in which the positive electrode plates and the negative electrode plates are alternately stacked and current collector leads are mounted for every predetermined number of plates;

FIG. 6 is a view of an example with a width varied according to the length of the current collector leads; and

FIG. 7 is a view of an example with a width and a bonding area varied according to the length of the current collector leads.

### DETAILED DESCRIPTION OF THE PREFERRED EMBODIMENT

The present invention is described in detail below based on an embodiment shown in the drawings.

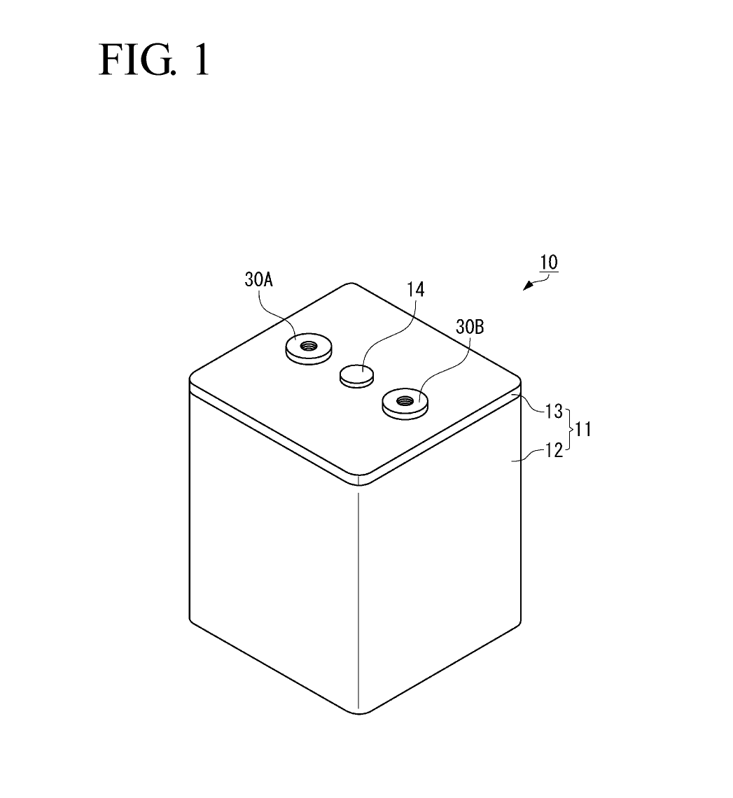

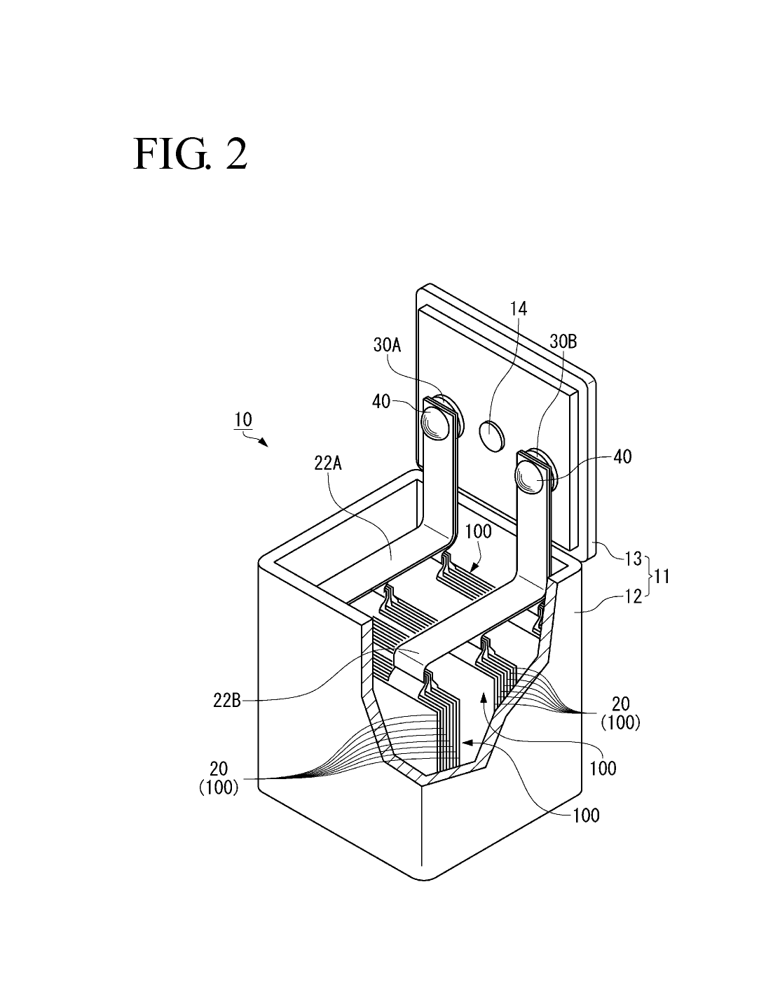

FIG. 1 and FIG. 2 are views for describing the schematic structure of a lithium secondary battery in the present embodiment.

As shown in FIG. 1, in a lithium secondary battery (i.e., a secondary battery) 10, a battery case 11 is formed with a battery case main body 12 in a closed-end cylindrical shape having one opening and a lid 13 closing the opening of the battery case main body 12. The battery case main body 12 and the lid 13 are formed of, for example, an aluminum-based material. And they are welded to hermetically seal the battery case 11.

The lid 13 is provided with a positive electrode terminal 30A and a negative electrode terminal 30B. Each of them communicates the inside of the battery case 11 with the outside of the battery case 11. The positive electrode terminal 30A is formed of, for example, an aluminum-based material, and the negative electrode terminal 30B is formed of, for example, a copper-based material.

Also, the lid 13 is provided with a safety valve 14 as a safety mechanism. When the temperature in the battery case 11 is increased due to some factor, the safety valve 14 opens because the internal pressure of the battery case 11 becomes equal to or higher than a predetermined value.

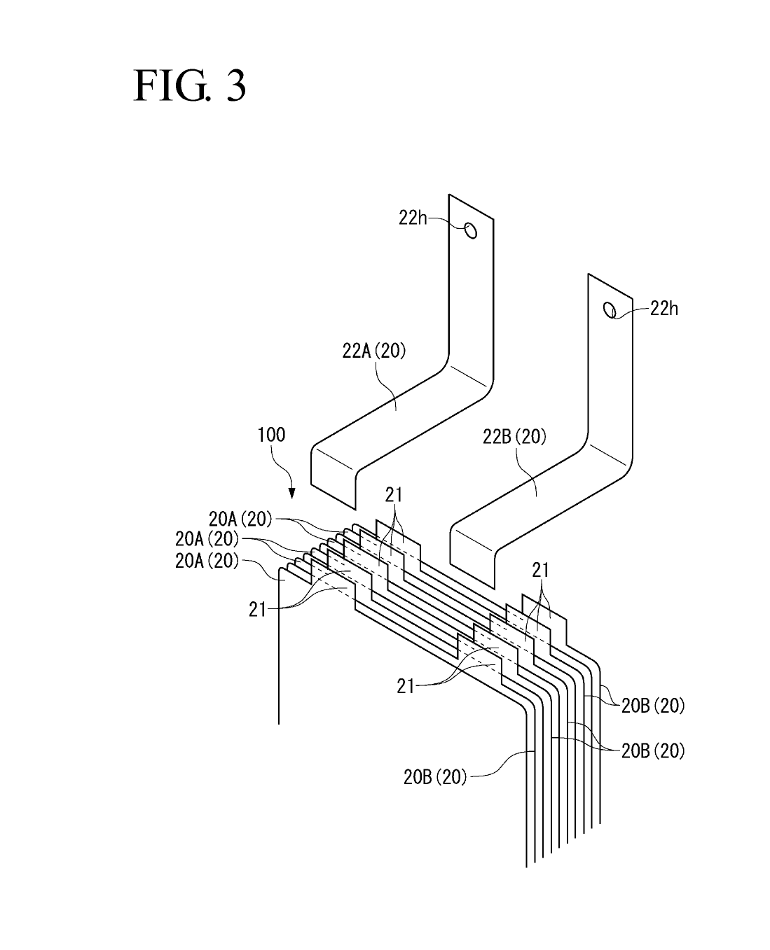

As shown in FIG. 2, in the battery case main body 12, a predetermined number of (for example, thirty) electrode plates 20 are stored. As shown in FIG. 3, these electrode plates 20 include positive electrode plates 20A and negative electrode plates 20B. For example, fifteen positive electrode plates 20A and fifteen negative electrode plates 20B are alternately stacked via separator films not shown so as not to establish a short circuit. The positive electrode plates 20A and negative electrode plates 20B have a predetermined thickness respectively, for example, 0.05 mm to 2 mm, preferably 0.2 mm. The electrode plate (i.e., the positive electrode plate and the negative electrode plate) has an approximately rectangular shape, and tub 21 is formed to protrude from an end of the electrode plate to the lid 13 in the battery case main body 12.

In the battery case main body 12, the tubs 21 of the positive electrode plates 20A and the tubs 21 of the negative electrode plates 20B are formed as being spaced apart from each other so as not to overlap each other.

And, a predetermined number, for example, every five, of the tubs 21 of the positive electrode plates 20A and the negative electrode plates 20B are bundled and connected to one end of the corresponding strap-shaped current collector lead 22A or 22B by, for example, a bonding means such as ultrasonic welding or the like. And, the other ends of these current collector leads 22A are connected to the positive electrode terminal 30A, and the other ends of these current collector leads 22B are connected to the negative electrode terminal 30B. In other words, the tubs 21 of five positive electrode plates 20A are bonded to one current collector lead 22A connected to the positive electrode terminal 30A, and the tubs 21 of five negative electrode plates 20B are bonded to one current collector lead 22B connected to the negative electrode terminal 30B.

The current collector lead 22A for the positive polarity connected to the positive electrode terminal 30A is formed of a material with high conductivity and flexibility (pliability), for example, an aluminum-based material. The current collector lead 22B for the negative polarity connected to the negative electrode terminal 30B is formed of also a material with high conductivity and flexibility (pliability), for example, a copper-based material. These current collector leads 22A and 22B each have a thickness of, for example, 0.05 mm to 2 mm, preferably 0.1 mm.

The positive electrode plates 20A and the negative electrode plates 20B are alternately placed as described above. Therefore, by connecting every five tubs 21 to the current collector lead 22A for the positive electrode terminal 30A and by connecting every five tubs 21 to the current collector lead 22B for the negative electrode terminal 30B, ten electrode plates in total are bundled into one to form a bundle 100 in this configuration.

Because all (e.g., in the above example, thirty) positive electrode plates 20A and negative electrode plates 20B stored in the battery case main body 12 are connected to the corresponding current collector leads 22A or 22B for every five electrode plates as described above, three bundles 100 are formed in total. And, three current collector leads 22A are connected to the positive electrode terminal 30A that are stacked each other, and three current collector leads 22B are connected to the negative electrode terminal 30B that are stacked each other.

The positive electrode terminal 30A and the plurality of (e.g., in the example described above, three) current collector leads 22A are fixed by using a rivet 40 through holes 22h formed at an end of the current collector leads 22A (for example, a bolt may be used instead of the rivet). And the negative electrode terminal 30B and the plurality of (e.g., in the example described above, three) current collector leads 22B are fixed by using a rivet 40 through holes 22h formed at an end of the current collector leads 22B (for example, a bolt may be used instead of the rivet).

Preferably, the rivet or the bolt mounted on the positive electrode terminal 30A is formed of, for example, an aluminum-based material. And the rivet or the bolt mounted on the negative electrode terminal 30B is formed of, for example, a copper-based material.

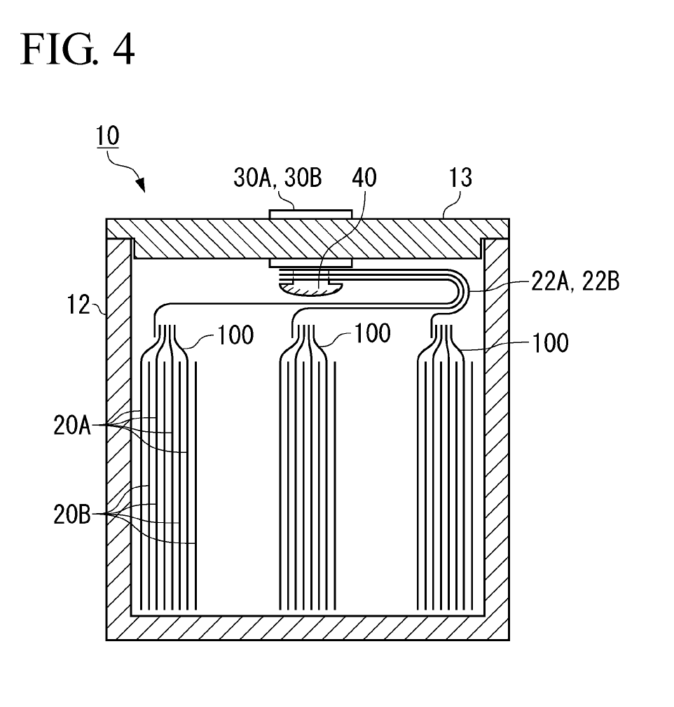

Meanwhile, in the lithium secondary battery 10 as described above, the current collector leads 22A and 22B for each bundle 100 are bent as shown in FIG. 4 in the battery case main body 12. Therefore, according to the position of the bundle 100 in the battery case main body 12, the lengths of the current collector leads are varied.

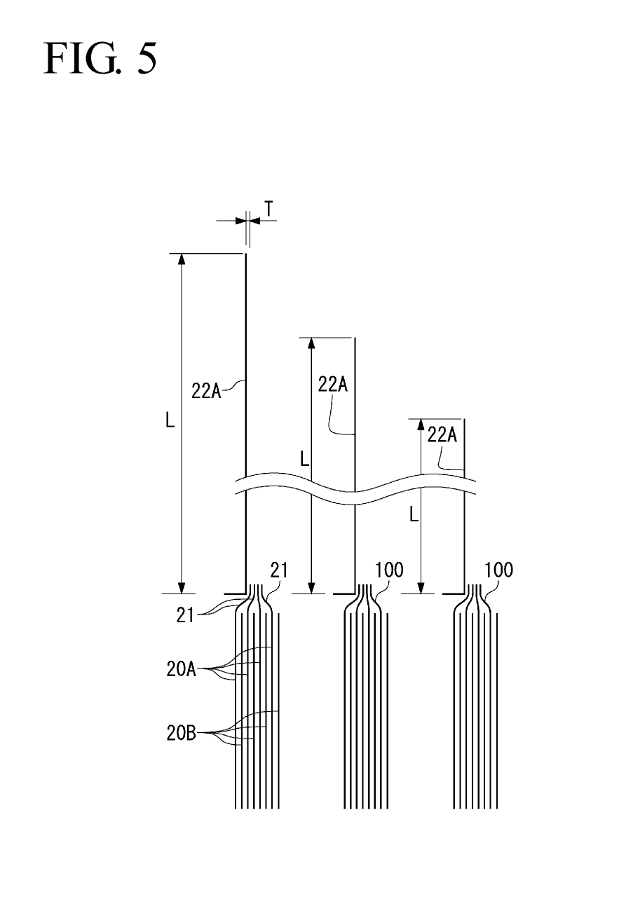

For this reason, the lengths L of the current collector leads 22A and 22B for each bundle 100 are adjusted in advance to be different from each other as shown in FIG. 5.

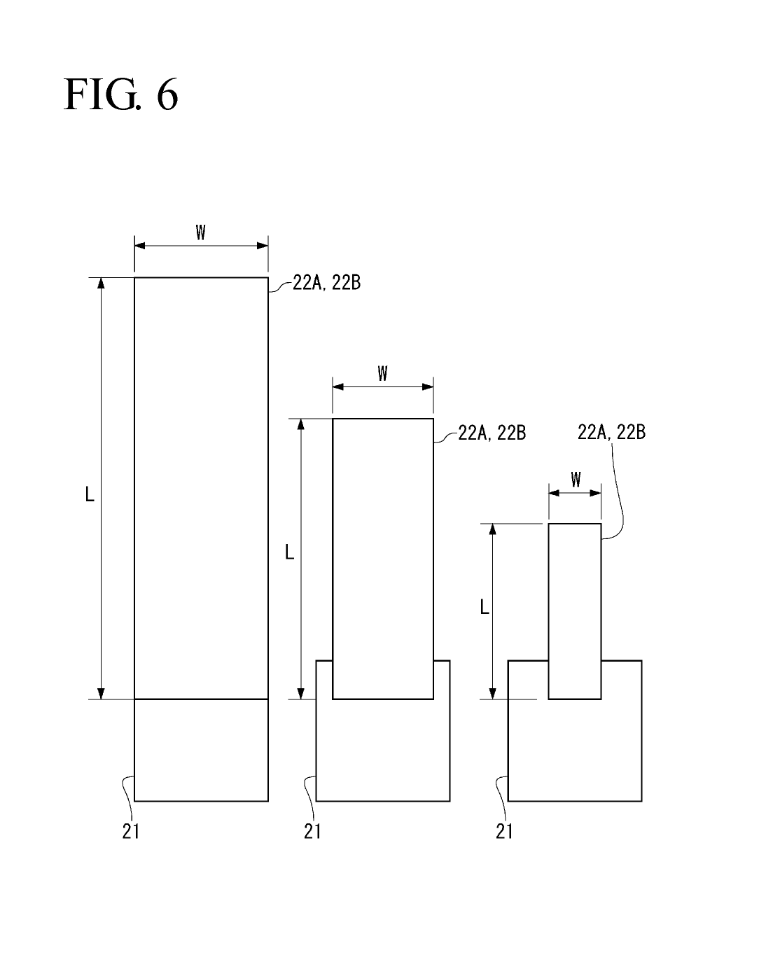

Furthermore, as shown in FIG. 6, according to the lengths L of the current collector leads 22A and 22B for each bundle 100, the corresponding widths W of the current collector leads 22A and 22B are adjusted to be different from each other. Specifically, the width W is increased as the length L of the current collector lead is longer. In more detail, the width W is preferably designed in order that electric resistances are equal to each other, although the lengths L of the current collector leads 22A and 22B are different. For the electric resistances to be substantially equal, not only the widths W but also the thicknesses T of the current collector leads 22A and 22B for each bundle 100 may be varied.

As described above, many positive electrode plates 20A and negative electrode plates 20B are stacked in the battery case main body 12 of the lithium secondary battery 10. Furthermore, the positive electrode plates 20A and the negative electrode plates 20B are bundled to form the bundle 100 for every predetermined number of the electrode plates. In each bundle 100, the positive electrode plates 20A and the negative electrode plates 20B are bonded to one strap-shaped current collector lead 22A and one strap-shaped current collector lead 22B, and these current collector leads 22A and 22B are connected to the positive electrode terminal 30A and the negative electrode terminal 30B, respectively.

Furthermore, according to the lengths L of the current collector leads 22A and 22B, the widths W of the current collector leads 22A and 22B are varied. Therefore, among the bundles 100, the electric resistances of the current collector leads can be the same. When a certain current is taken out from the lithium secondary battery 10, the electric resistances among the bundles 100 can be the same or similar, current does not flow much more from a specific bundle 100, and the bundles 100 can be deteriorated similarly. As a result, the life of the lithium secondary battery 10 can be enhanced.

### OTHER EMBODIMENTS

As described above, the widths W of the current collector leads 22A and 22B are varied according to the lengths L of the current collector leads 22A and 22B. However, the sizes of the bonded area, which is an area for connecting or bonding the current collector lead and the tub, may be varied according to the lengths L of the current collector leads.

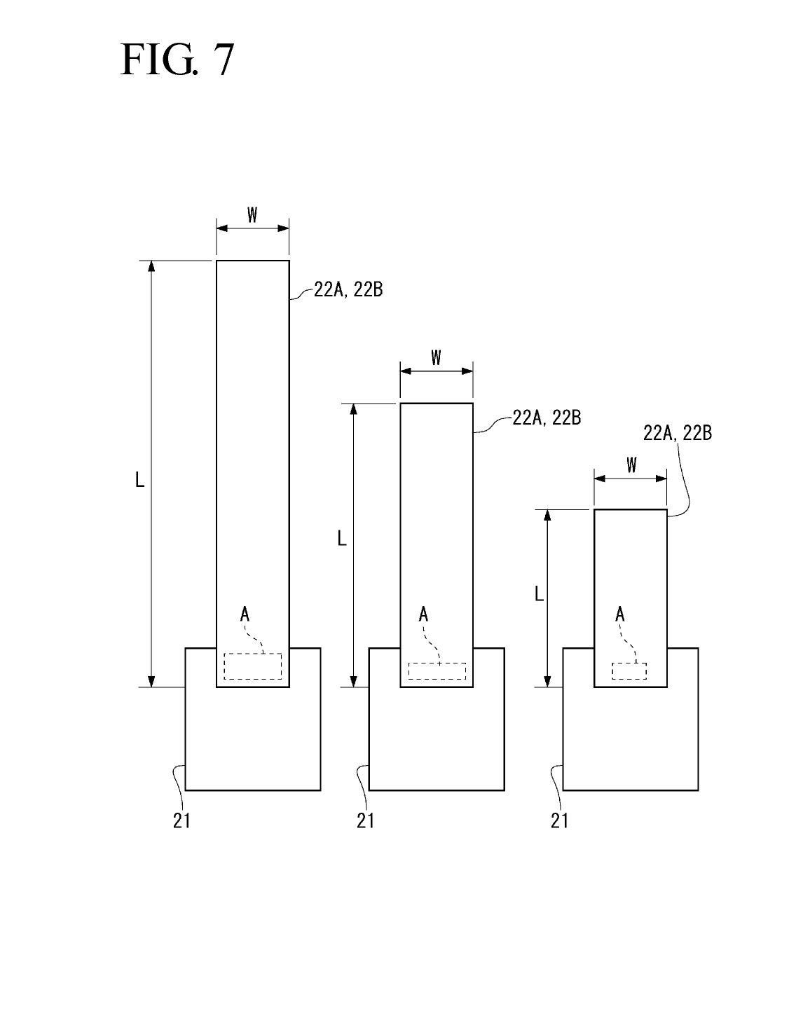

In this case, as shown in FIG. 7, the current collector leads 22A or 22B and the tubs 21 of the electrode plates 20A or 20B are bonded at the bonded area by, for example, the ultrasonic welding. As the length L of the current collector lead 22A or 22B of each bundle 100 is larger, the bonded area A for bonding the current collector lead and the tub 21 of the electrode plates is increased.

Therefore, the electric resistances of the current collector leads can be the same among the bundles 100. When certain current is taken out from the lithium secondary battery 10, because the electric resistances among the bundles 100 can be the same or similar, current does not flow much from a specific bundle 100. So, deteriorations of the respective bundles 100 can be equal or similar. As a result, the life of the lithium secondary battery 10 can be enhanced.

At this time, the widths W of the current collector leads 22A and 22B are preferably varied according to the length L of the current collector leads 22A and 22B for each bundle 100, but this does not mean to exclude an embodiment in which the widths W of the current collector leads 22A and 22B are constant in a case that the lengths L of the current collector leads 22A and 22B of each bundle 100 are different.

However, when the lithium secondary battery 10 is large in size and a difference in the lengths L of the current collector leads 22A and 22B is large among the bundles 100, the widths W of the current collector leads 22A and 22B may be too large only by varying the widths W of the current collector leads 22A and 22B. In such cases, by combining varying the widths W of the current collector leads 22A and 22B and varying the bonding areas A together, the widths W of the current collector leads 22A and 22B can be suppressed.

As mentioned above, the current collector leads 22A and 22B are fixed to the positive electrode terminal 30A and the negative electrode terminal 30B as an example. However, the structure is not limited to the one in which the rivets 40 and the bolts are used. Other fixing members may be used, or a configuration of the structure can be such that the current collector leads 22A and 22B are directly welded to the positive electrode terminal 30A and the negative electrode terminal 30B by a welding means such as spot welding, projection welding, or ultrasonic welding, without using various fixing members.

Furthermore, while the lithium secondary battery 10 is exemplarily described as a secondary battery in the embodiment, the present invention can also be applied to a secondary battery of another type as long as the secondary battery includes a configuration similar to the one in which many electrode plates 20 are stored in the battery case 11.

Other than the above, the configurations cited in the above described embodiment can be selected or omitted, or can be arbitrarily changed to the other configurations, without departing from the scope of the present invention.

### REFERENCE SIGNS LIST

10 . . . lithium secondary battery
11 . . . battery case
12 . . . battery case main body
13 . . . lid
14 . . . safety valve
20 . . . polar plate
20A . . . positive electrode plate
20B . . . negative electrode plate
21 . . . tub
22A . . . current corrector lead
22B . . . current corrector lead
22h . . . hole
30A . . . positive electrode terminal
30B . . . negative electrode terminal
100 . . . bundle

1. A secondary battery comprising:
stacked bodies, each formed by alternately stacking positive electrode plates and negative electrode plates, in a battery case;
a positive electrode terminal and a negative electrode terminal for communicating the inside of the battery case with the outside of the battery case; and
strap-shaped current collector leads, each for electrically connecting the corresponding electrode plate and the corresponding electrode terminal, in each polarity,
wherein at least either widths or thicknesses of the current collector leads are varied according to the length of the corresponding current collector lead connected to the corresponding stacked body among the stacked bodies.

2. The secondary battery according to claim 1, wherein at least either the widths or the thicknesses of the current collector leads are varied, in order that current collector resistance values of the stacked bodies are substantially the same.

3. A secondary battery comprising:
stacked bodies, each formed by alternately stacking positive electrode plates and negative electrode plates, in a battery case;
a positive electrode terminal and a negative electrode terminal for communicating the inside of the battery case with the outside of the battery case; and
strap-shaped current collector leads, each for electrically connecting the corresponding electrode plate and the corresponding electrode terminal, in each polarity,
wherein the electrode plate and the corresponding current collector lead are electrically connected by connecting a tub formed in the electrode plate and one end of the corresponding current collector lead, and its bonded area is designed in order that current corrector resistance values of the stacked bodies are substantially the same with considering lengths, widths, and thicknesses of the current collector leads connected to the stacked bodies.
